(19) United States
(12) Patent Application Publication
(10) Pub. No.: US 2018/0059605 A1
(43) Pub. Date: Mar. 1, 2018

(54) IMAGE FORMING APPARATUS, CONTROL METHOD FOR IMAGE FORMING APPARATUS, AND NON-TRANSITORY COMPUTER-READABLE STORAGE MEDIUM

(71) Applicant: CANON KABUSHIKI KAISHA, Tokyo (JP)

(72) Inventor: Shigeo Hongu, Toride-shi (JP)

(21) Appl. No.: 15/671,640

(22) Filed: Aug. 8, 2017

(30) Foreign Application Priority Data
Aug. 23, 2016 (JP) 2016-163043

(51) Int. Cl. G03G 15/00; G03G 15/08

(52) U.S. Cl. CPC G03G 15/556

(57) ABSTRACT

An image forming apparatus including: an image forming portion configured to form an image on a recoding medium; an obtaining unit configured to obtain consumption information indicating a consumption state of a consumable mounted to the image forming apparatus; a setting unit configured to set changeover information including information indicating a period in which productivity of the image forming apparatus is to be changed over; a control portion configured to control the image forming portion in order to change over the productivity of the image forming apparatus based on the changeover information; and a decision portion configured to decide, based on the consumption information and the changeover information, a timing to provide a notification for prompting preparation of a replacement article of the consumable.

### BACKGROUND OF THE INVENTION

### Field of the Invention

The present invention relates to an image forming apparatus, a control method for an image forming apparatus, and a non-transitory computer-readable storage medium.

### Description of the Related Art

Hitherto, there has been proposed a configuration having an automatic delivery function of automatically requesting delivery of a consumable for replacement before an image can no longer be formed due to complete consumption of a consumable of an image forming apparatus. The automatic delivery function automatically outputs a notification for prompting arrangement for delivery of a replacement article when a consumption rate that is set so that images can be formed for a period longer than a period required for delivery is reached.

Further, in regards to such an automatic delivery function, for example, there has been proposed a technology for changing over a timing to provide a notification for delivery of a replacement article based on past consumption records of individual apparatus (Japanese Patent Application Laid-Open No. 2015-18008). The apparatus proposed in Japanese Patent Application Laid-Open No. 2015-18008 is configured to calculate a period required for consumption of a consumable based on history of the consumption rate of the consumable and determine a timing to provide a notification for prompting arrangement of a replacement article based on a result of comparison between the calculated period and a period required for delivery.

Meanwhile, in recent years, there has been known an image forming apparatus capable of temporarily changing over its printing productivity to that of a high-productivity model based on a setting operation by a person in charge of maintenance. In other words, the image forming apparatus can temporarily change over its productivity when a user temporarily changes his or her contract. It can be predicted that a consumption speed of a consumable varies along with a change in productivity in such an image forming apparatus capable of changing over its productivity.

However, there is a problem in that such a variation in consumption speed is not taken into consideration in the related-art automatic delivery function, and a timing to deliver the replacement article is not appropriate in some cases. When the timing to deliver the replacement article is too late or too early, a burden is imposed on the user, and usability is thus decreased. For example, when the timing is too late, the apparatus cannot be used for a longer period until the consumable is replaced, whereas when the timing is too early, space for storing the consumable is required. It is therefore important that the timing to deliver the replacement article be accurate (that the replacement article be delivered at an appropriate timing).

### SUMMARY OF THE INVENTION

The present invention provides a system configured to prepare a consumable of an image forming apparatus at an appropriate timing even when productivity of the image forming apparatus is changed over.

According to one embodiment of the present invention, there is provided an image forming apparatus comprising:

an image forming portion configured to form an image on a recoding medium;

an obtaining unit configured to obtain consumption information indicating a consumption state of a consumable mounted to the image forming apparatus;

a setting unit configured to set changeover information including information indicating a period in which productivity of the image forming apparatus is to be changed over;

a control portion configured to control the image forming portion in order to change over the productivity of the image forming apparatus based on the changeover information; and

a decision portion configured to decide, based on the consumption information and the changeover information, a timing to provide a notification for prompting preparation of a replacement article of the consumable.

Further features of the present invention will become apparent from the following description of exemplary embodiments with reference to the attached drawings.

### BRIEF DESCRIPTION OF THE DRAWINGS

FIG. 1 is a view for illustrating an example of an overall configuration of an image forming apparatus according to an embodiment.

FIG. 2 is a cross-sectional view for illustrating a configuration example of an image forming portion and an image forming operation.

FIG. 3 is a block diagram for illustrating an example of a control circuit configuration of the image forming apparatus according to the embodiment.

FIG. 4 is a graph for showing a consumption rate and an automatic delivery notification timing of a known automatic delivery function.

FIG. 5 is a table for showing an example of reservation setting information of a productivity changeover function.

FIG. 6A and FIG. 6B are graphs for showing a consumption rate and an automatic delivery notification timing of an automatic delivery function of the embodiment.

FIG. 7 is a flowchart for illustrating an example of a toner remaining amount checking operation process of the embodiment.

FIG. 8 is a flowchart for illustrating an example of an automatic delivery notification determination process of the embodiment.

### DESCRIPTION OF THE EMBODIMENTS

Now, one embodiment of the present invention will be described. The embodiment to be described below is useful for understanding various concepts of the present invention such as a superordinate concept, an intermediate concept, and a subordinate concept. Further, the technical scope of the present invention is defined by the appended claims, and is not limited by the embodiment to be described below.

### Configuration of Entire Apparatus

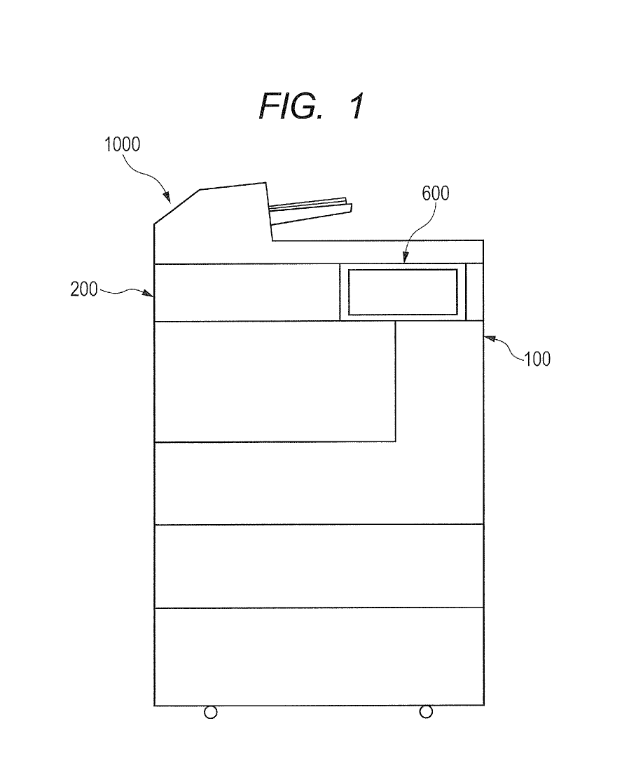

FIG. 1 is a view for illustrating an example of an overall configuration of an image forming apparatus 1000 according to one embodiment of the present invention.

As illustrated in FIG. 1, the image forming apparatus 1000 according to the embodiment includes an original reading portion 200, an image forming portion 100, a UI portion 600, and other portions.

The original reading portion 200 is configured to read an original placed on an original table glass and output obtained image data. The image forming portion 100 is configured to form an image on a recoding medium (sheet, for example, sheet of paper; hereinafter referred to as “sheet”) based on the image data output from the original reading portion 200 or image data input from an external apparatus connected to the image forming apparatus 1000 via a network. The UI portion 600 is an operating portion, which includes a liquid crystal display equipped with a touch panel and others, and is configured to present information to a user and receive an input operation of, for example, specifying the number of sheets to be printed via a graphical user interface (GUI).

### Configuration of Image Forming Portion 100

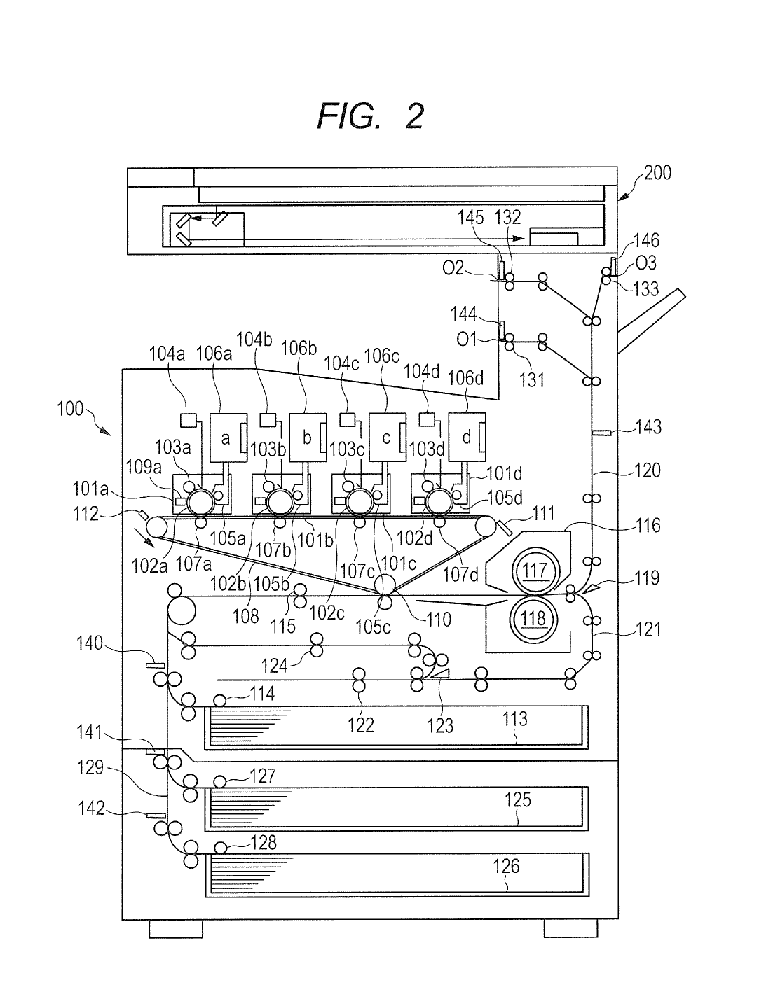

FIG. 2 is a cross-sectional view for illustrating a configuration example of the image forming portion 100 and an image forming operation.

Process units 101a, 101b, 101c, and 101d are process units for a plurality of colors (e.g., black, yellow, cyan, and magenta), and include photosensitive drums 102a, 102b, 102c, and 102d, developing devices 105a, 105b, 105c, and 105d, and charging rollers 103a, 103b, 103c, and 103d, respectively.

The photosensitive drum 102a is housed in the process unit 101a, and the photosensitive drum 102a is rotated by a drum motor (not shown). The charging roller 103a applies high voltage to the photosensitive drum 102a to uniformly charge a surface of the photosensitive drum 102a. A laser scanner unit 104a uses a rotary polygon mirror to scan laser light modulated to be output from a laser diode onto the photosensitive drum 102a in a main scanning direction. The laser scanner unit 104a exposes the uniformly charged photosensitive drum 102a to laser light based on input image information to form an electrostatic latent image.

The developing device 105a uses a two-component developer comprising toner and carrier to form a visible toner image corresponding to the electrostatic latent image on the photosensitive drum 102a. A toner bottle unit 106a includes a toner bottle filled with toner and a toner conveying mechanism, and supplies the developing device 105a with toner. Toner is a consumable, and hence the toner bottle is formed so as to be attachable/detachable and replaceable.

A primary transfer roller 107a is used to primarily transfer the toner image from the photosensitive drum 102a onto an intermediate transfer member 108, which is an endless belt member. An auxiliary charging brush 109a charges residual toner having failed to be transferred by the primary transfer roller 107a such that the residual toner has uniform charges.

The process unit 101a is described above, but the process units 101b, 101c, and 101d have the same configurations. In the following, when the components of the process units 101a, 101b, 101c, and 101d are written as the photosensitive drum 102, the charging roller 103, the developing device 105, the toner bottle unit 106, and the auxiliary charging brush 109, description of those components is common to the process units 101a, 101b, 101c, and 101d.

Secondary transfer rollers 110 secondarily transfer the toner image primarily transferred onto the intermediate transfer member 108 as described above onto a sheet. An intermediate transfer member cleaner 111 collects residual toner having failed to be transferred by the secondary transfer rollers 110 and a toner image for adjustment, which is not intended to be transferred onto a sheet, and stores the collected toner in a residual toner container (not shown). A pattern density detection sensor 112 detects a change in density of a pattern formed as an image on the intermediate transfer member 108.

A feeding cassette 113, a second additional feeding cassette 125, a third additional feeding cassette 126 each store sheets. A feeding roller 114 feeds a sheet from the feed cassette 113. A feeding roller 127 feeds a sheet from the second additional feeding cassette 125. A feeding roller 128 feeds a sheet from the third additional feeding cassette 126.

Registration rollers 115 correct skew feeding of the sheet fed thereto and send the sheet to the secondary transfer rollers 110. The secondary transfer rollers 110 transfer the toner image onto the sheet. A fixing roller 117 and a pressure roller 118 of a fixing device 116 fix the toner image transferred onto the sheet by heat. A discharge flapper 119 sends the sheet having the toner image fixed thereto to a discharge path 120 or a double-sided printing inversion path 121. The sheet is conveyed to one of discharge ports O1, O2, and O3 via the discharge path 120.

On a sheet conveyance path 129, sheet detectors 140, 141, and 142 are arranged, and on the discharge path 120, sheet detectors 143, 144, 145, and 146 are arranged. Detection signals obtained by the sheet detectors 140, 141, 142, 143, 144, 145, and 146 are used for sheet conveyance control and detection of a jammed state.

The sheet sent to the double-sided printing inversion path 121 is sent to double-sided printing refeeding rollers 124 by reverse rotation of inversion rollers 122 and rotation of a double-sided printing inversion flapper 123, and the other side of the sheet is subjected to image formation again. The resultant sheet is then sent to one of the discharge ports O1, O2, and O3. In the vicinities of the discharge ports O1, O2, and O3, discharge rollers 131, 132, and 133 are arranged, respectively. The discharge rollers 131, 132, and 133 send sheets, which are sent to the discharge ports O1, O2, and O3, respectively, to discharge the sheets to the outside of the image forming apparatus 1000.

### Control Circuit Configuration of Image Forming Apparatus 1000

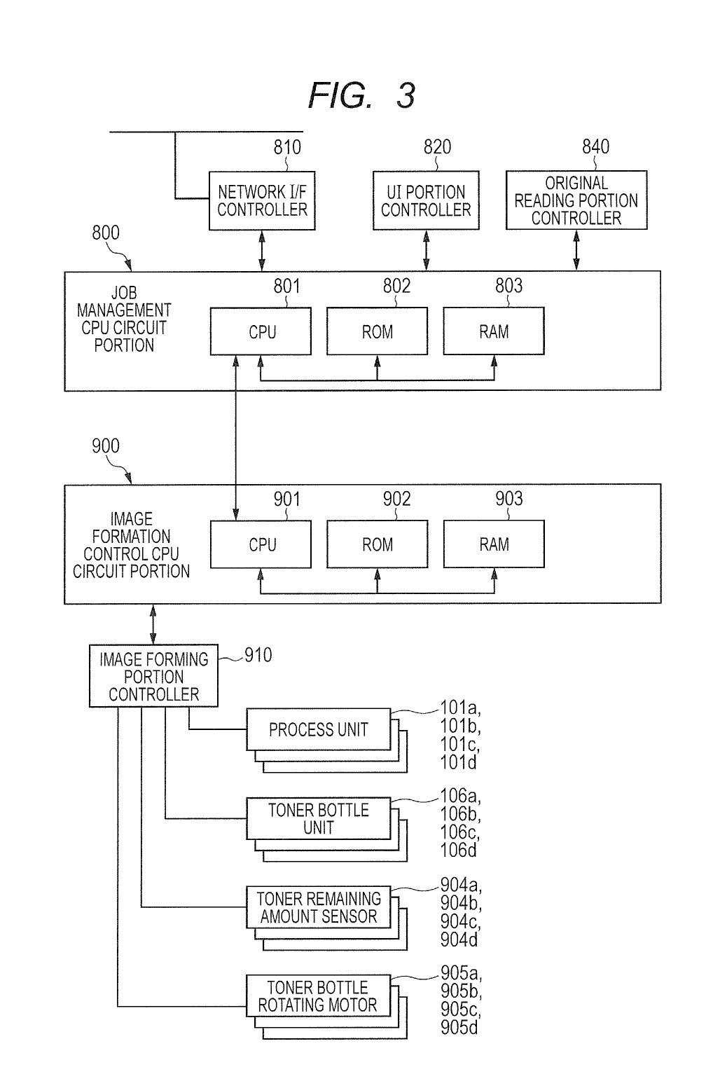

FIG. 3 is a block diagram for illustrating an example of a control circuit configuration of the image forming apparatus 1000.

In FIG. 3, a job management CPU circuit portion 800 includes a CPU 801, a ROM 802, and a RAM 803. The CPU 801 controls a network I/F controller 810, a UI portion controller 820, and an original reading portion controller 840. The ROM 802 stores programs to be used by the CPU 801 for operation. The RAM 803 has a backup storage function, and is used to temporarily store, as data, a result of calculation performed by the CPU 801.

An image formation control CPU circuit portion 900 includes a CPU 901, a ROM 902, and a RAM 903. The CPU 901 exchanges, with the CPU 801, a job, image data, information on a consumable, for example, toner, and other data, and controls an image forming portion controller 910. The ROM 902 stores programs to be used by the CPU 901 for operation. The RAM 903 has a backup storage function, and is used to temporarily store, as data, a result of calculation performed by the CPU 901.

The network I/F controller 810 is connected to an external network, and controls communication to/from an external apparatus of job data and information relating to management of a consumable, for example, toner. The UI portion controller 820 controls the UI portion 600, and exchanges a signal relating to a job operation with the CPU 801. The original reading portion controller 840 controls the original reading portion 200 to read an original, and passes the obtained image data to the CPU 801.

The image forming portion controller 910 controls units involved in image formation by, for example, driving a drum motor (not shown) based on a control signal sent from the CPU 901. The units involved in image formation include, for example, the process units 101a to 101d, the toner bottle units 106a to 106d, toner remaining amount sensors 904a to 904d, and toner bottle rotating motors 905a to 905d.

The toner bottle unit 106 is configured to drive the toner bottle rotating motor 905 to supply toner to the corresponding process unit 101. The toner remaining amount sensors 904a to 904d are arranged on supply paths for toner supplied from the toner bottle units 106a to 106d to detect the toner supplied from the toner bottle units 106a to 106d, respectively. The toner remaining amount sensors 904a to 904d detect the toner supplied from the toner bottle units 106a to 106d in this manner so that it can be determined whether or not toner remains in the toner bottle units 106a to 106d.

The image forming portion controller 910 further control units involved in sheet conveyance such as the feeding cassettes 113, 125, and 126 by, for example, driving the feeding rollers 114, 127, and 128 with a feeding motor (not shown). In addition, the image forming portion controller 910 control units involved in a fixing operation by, for example, driving the fixing roller 117 and the pressure roller 118 with a fixing motor (not shown) and then heating the fixing roller 117 and the pressure roller 118 with a fixing heater (not shown). The above-mentioned control performed by the image forming portion controller 910 is an example, and the present invention is not limited thereto.

Further, another configuration such as one processor, two processors, or a combination of an ASIC and a CPU may be adopted as a configuration of the CPU 801, the CPU 910, and the image forming portion controller 910.

### Description of Known Automatic Delivery Function

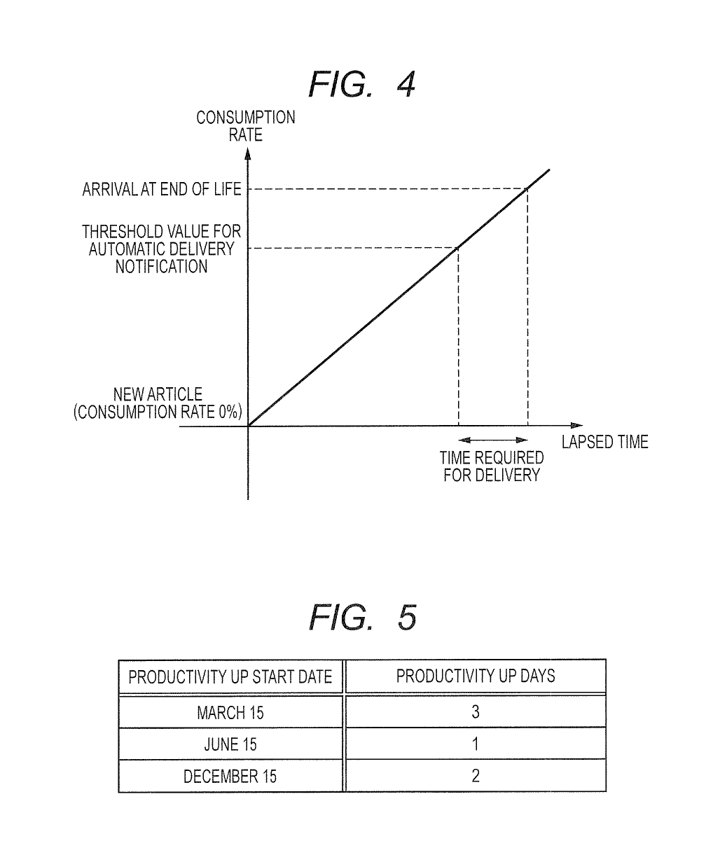

Now, referring to FIG. 4, a known consumable automatic delivery function that does not take productivity changeover into consideration will be described.

FIG. 4 is a graph for showing a relationship between a consumption rate of a consumable and a lapsed time, and an automatic delivery notification timing in the known consumable automatic delivery function. In the graph of FIG. 4, there are shown a relationship between a consumption rate of a consumable of the image forming apparatus 1000 and the lapsed time, and the automatic delivery notification timing until a consumption rate of the consumable increases as the number of times of printing increases from a state in which the consumption rate is 0%, and then a replacement timing corresponding to a consumption rate of 100% arrives when the consumable is completely consumed.

It is assumed here that the consumable of the embodiment is, for example, the toner bottle, and that the consumption rate is detected by, for example, a known consumption detection method with counter management in which a toner usage amount is calculated based on a cumulative rotation time for which the toner bottle rotating motor 905 has been rotated.

In the automatic delivery function, as shown in FIG. 4, when the consumption rate reaches a predetermined consumption rate (value indicated by threshold value for automatic delivery notification), automatic delivery is arranged (automatic delivery notification is provided). To provide the automatic delivery notification, for example, the CPU 901 outputs an automatic delivery notification signal to the CPU 801, and when receiving the automatic delivery notification signal, the CPU 801 controls the network I/F controller 810 to send, to a maintenance system via the external network, an email for ordering a replacement article in order to arrange the consumable, and controls the UI portion controller 820 to output a screen for requesting a person in charge of maintenance to prepare the replacement article.

A predetermined threshold value of the consumption rate for providing the automatic delivery notification (threshold value for automatic delivery notification) is set in advance to such a value as to allow a predetermined average delivery period to be secured, which is required for delivering the consumable before the consumption rate of 100% is reached when the consumable is consumed at a predetermined average consumption speed. In this manner, when the image forming apparatus is used averagely by a user, the automatic delivery function functions such that a new replacement article is delivered to the user before the consumption rate of the consumable reaches 100%. However, with the known consumable automatic delivery function, because a productivity changeover function to be described below is not taken into consideration, the replacement article may fail to be delivered in time when the changeover of the productivity occurs.

### Description of Productivity Changeover Function

Now, referring to FIG. 5, the productivity changeover function of the image forming apparatus 1000 will be described.

FIG. 5 is a table for showing an example of reservation setting information indicating a date at which productivity is to be changed over to high productivity and the number of days of high productivity, which is held in the RAM 803.

Under the condition that, for example, the user has made a charging contract, the CPU 801 serving as a setting unit controls the network I/F controller 810 to receive, from the maintenance system via the external network, the reservation setting information (changeover information) shown as an example in FIG. 5, and stores the reservation setting information in the RAM 803. Further, the CPU 801 controls the UI portion controller 820 to receive the reservation setting information set by the person in charge of maintenance, and stores the reservation setting information in the RAM 803. The CPU 901 and the CPU 801 serving as a changeover unit configured to change over the productivity of the image forming apparatus 1000 performs control such that an image is formed with the productivity that is based on the reservation setting information stored in the RAM 803. In this case, the reservation setting information is transmitted from the CPU 801 to the CPU 901 when the image forming apparatus 1000 is powered on and when setting information is updated, and in response to the request from the CPU 901. The CPU 901 performs automatic delivery determination to be described later based on the reservation setting information. The CPU (control portion) 901 controls the image forming portion controller 910 configured to control the image forming portion 100 in order to change over the productivity of the image forming apparatus 1000 based on the reservation setting information.

### Description of Automatic Delivery Function of The Embodiment

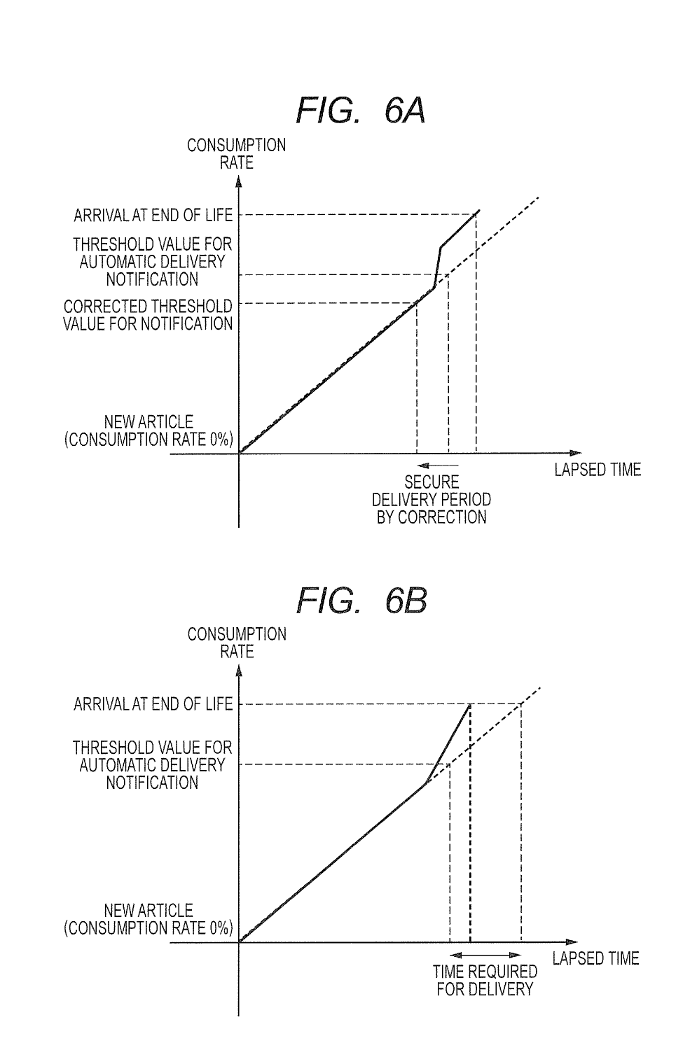

Now, the consumable automatic delivery determination that takes into consideration a change of productivity in the image forming apparatus 1000 that can be changed over to a high-productivity model, that is, a consumable automatic delivery function that takes productivity changeover into consideration will be described. First, referring to FIG. 6A and FIG. 6B, a technical idea will be described.

FIG. 6A and FIG. 6B are graphs for showing a relationship between a consumption rate of the consumable managed by the image forming portion 100, for example, a toner usage amount, and the lapsed time, and an automatic delivery notification timing. FIG. 6A corresponds to a case where the method of the embodiment is used, and FIG. 6B corresponds to a case where the method of the embodiment is not used.

In FIG. 6A, the following case is indicated by the solid line rising to the right: during a period of about one to two days a little before the automatic delivery notification is provided, a consumption speed increases sharply due to the changeover to a high-productivity model, and then the productivity returns to the original productivity and the consumption speed also returns to the state before the sharp increase (original state).

Further, in FIG. 6A, the dotted line rising to the right indicates an average consumption speed that is assumed in advance for a case where the image forming apparatus 1000 is used at normal productivity. The threshold value for automatic delivery notification is set to such a predetermined threshold value that the notification is provided at a timing that precedes the arrival of the end of life of the consumable by a period corresponding to the period required for delivery of the replacement article when the consumable is consumed at the assumed average consumption speed.

In the embodiment, through correction of the threshold value for automatic delivery notification to be described later, the threshold value for automatic delivery notification is corrected to a “corrected threshold value for notification” shown in FIG. 6A. With this correction, even when the image forming apparatus 1000 is changed over to a high-productivity model and there is a period in which the consumable is consumed at a speed higher than the average consumption speed, the replacement article can be delivered before the end of life of the consumable arrives.

Meanwhile, the following case is shown in FIG. 6B. Specifically, FIG. 6B corresponds to the case where the method of the embodiment is not used, and hence the threshold value for automatic delivery notification is not corrected. Thus, when the image forming apparatus 1000 is changed over to a high-productivity model in the middle and the consumption speed thus becomes higher (indicted by the solid line) than the assumed average consumption speed indicated by the dotted line rising to the right, the end of life of the consumable arrives before the replacement article is delivered after the automatic delivery notification is provided.

According to the embodiment, as described above, the automatic delivery notification is provided in advance in consideration of the period in which the image forming apparatus is changed over to a high-productivity model. Thus, a period required for delivery is secured to allow automatic delivery even for the image forming apparatus that can be changed over to a high-productivity model. The embodiment focuses on this point.

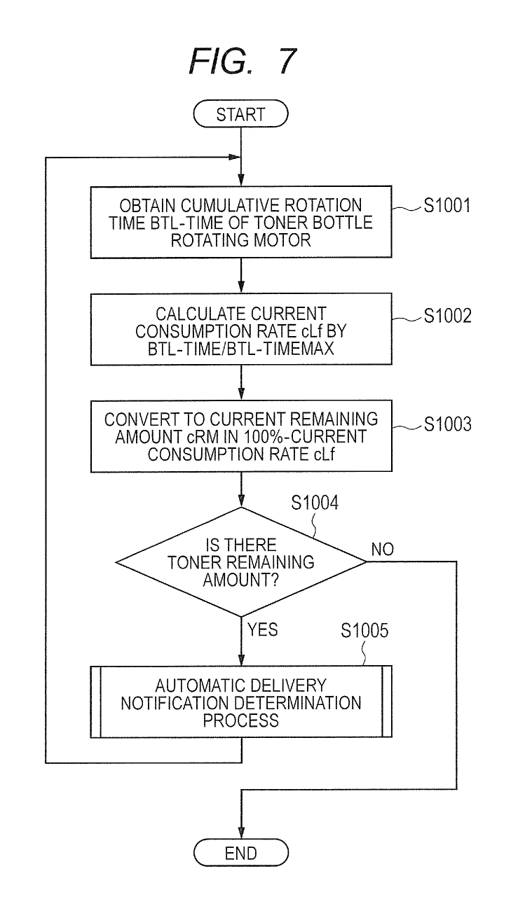

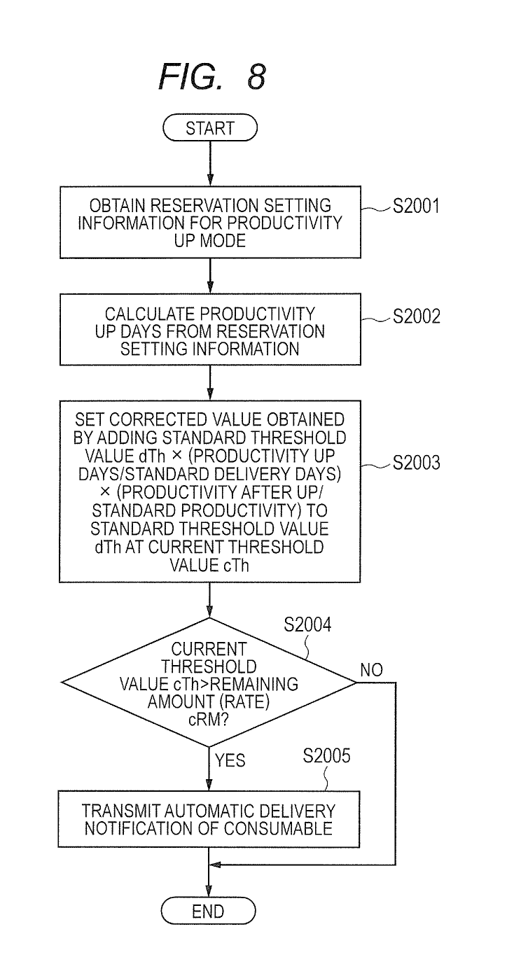

Next, referring to FIG. 7 and FIG. 8, an operation of the CPU 901 for implementing the automatic delivery function described above with reference to FIG. 6A will be described.

FIG. 7 is a flowchart for illustrating an example of a toner remaining amount checking operation process of the embodiment. The process of the flowchart of FIG. 7 is implemented by the CPU 901 of the image formation control CPU circuit portion 900 executing a program stored in the ROM 902. The process of the flowchart of FIG. 7 is executed, for example, when the image forming apparatus 1000 is powered on or after the consumable is replaced, but may be started at another timing.

When the process of the flowchart of FIG. 7 is started, in order to start checking a toner remaining amount, in Step S1001, the CPU 901 obtains a cumulative rotation time BTL-TIME of the toner bottle rotating motor 905 from the RAM 903. For example, when controlling the toner bottle rotating motor 905 for rotation, the CPU 901 adds a rotation time of the toner bottle rotating motor 905 and stores the rotation time in the RAM 903.

Next, in Step S1002, in order to calculate a current toner bottle consumption rate cLf, the CPU 901 divides BTL-TIME obtained in Step S1001 by a predetermined maximum rotation time BTL-TIMEMAX (cLf=BTL-TIME/BTL-TIMEMAX). In this case, BTL-TIMEMAX is a predetermined cumulative rotation time after which the toner bottle needs to be replaced, and is set in advance based on a toner consumption amount of the toner bottle rotating motor 905 per unit rotation time and a toner capacity of the toner bottle. BTL-TIMEMAX is stored in, for example, the ROM 902. In this case, the CPU 901 calculates the current consumption rate cLf in percentage terms.

Next, in Step S1003, in order to convert the current consumption rate cLf calculated in Step S1002 to a remaining amount cRM(%), the CPU 901 calculates “(remaining amount cRM)=100%×(current consumption rate cLf)” to calculate the current remaining amount cRM. In other words, in Steps S1001 to S1003, the CPU 901 serving as an obtaining unit obtains consumption information (remaining amount cRM in the above-mentioned example) indicating the consumption state of the consumable mounted to the image forming portion 100.

Next, in Step S1004, the CPU 901 refers to the state of the toner remaining amount sensor 904 to determine whether or not there is toner in the toner bottle. Then, when it is determined that there is no toner in the toner bottle (“NO” in Step S1004), the CPU 901 ends the process of the flowchart.

Meanwhile, when it is determined that there is toner in the toner bottle (“YES” in Step S1004), the CPU 901 advances the process to Step S1005. In Step S1005, the CPU 901 executes an automatic delivery notification determination process illustrated in FIG. 8 to be described later, and returns the process to Step S1001.

Next, referring to FIG. 8, the automatic delivery notification determination process of the embodiment will be described.

FIG. 8 is a flowchart for illustrating an example of the automatic delivery notification determination process of the embodiment. The process of the flowchart of FIG. 8 is implemented by the CPU 901 executing a program stored in the ROM 902.

First, in Step S2001, the CPU 901 obtains the reservation setting information for changeover to high productivity from the RAM 803 via the CPU 801.

Next, in Step S2002, the CPU 901 calculates, based on the reservation setting information obtained in Step S2001, the number of high productivity days reserved within a predetermined number of standard delivery days. The reservation setting information (changeover information) includes information indicating a period in which the productivity of the image forming apparatus 1000 is to be changed over. The predetermined number of standard delivery days in this case is, for example, a predetermined number of days (e.g., seven days) for securing a period required until the replacement article is delivered by the above-mentioned automatic delivery function. The predetermined number of standard delivery days is set in advance and stored in, for example, the ROM 902. The reserved number of high productivity days serving as information indicating a period in which the productivity is to be changed over is referred to as “productivity UP days”.

Next, in Step S2003, the CPU 901 uses a predetermined expression to calculate, based on the number of days calculated in Step S2002, a new current threshold value cTh at which the automatic delivery notification is to be output. In this case, the current threshold value cTh is calculated through use of Expression 1 given below. The “current threshold value cTh” calculated in the step corresponds to the “corrected threshold value for notification” of FIG. 6A.

(Current threshold value cTh)=(predetermined standard threshold valued dTh)+(predetermined standard threshold valued dTh)×((productivity UP days)/(standard delivery days))×((productivity after UP)/(standard productivity)) Expression 1

In Expression 1, a proportion of the number of productivity UP days to the number of standard delivery days to be secured is calculated, and the proportion is multiplied by a rate by which the productivity is increased, to thereby calculate a rate of contribution of the changeover to high productivity to the consumption speed of the consumable to correct the predetermined standard threshold valued dTh. The predetermined standard threshold valued dTh, the number of standard delivery days, the productivity after UP, the standard productivity, and other values are set in advance and stored in, for example, the ROM 902. A method of correcting the threshold value is not limited to Expression 1. The threshold value can be similarly corrected by, for example, setting in advance predetermined values corresponding to the numbers of days, and storing the predetermined values as a data table in the ROM 802 or the ROM 902. The predetermined values corresponding to the numbers of days are, for example, a threshold value of 22% when the predetermined standard threshold value dTh is 20% and the number of productivity UP days is one and a threshold value of 24% when the number of productivity UP days is two.

Next, in Step S2004, the CPU 901 compares the current threshold value cTh calculated in Step S2003 with the remaining amount (rate) cRM calculated in Step S1003 of FIG. 7 to determine whether or not the current threshold value cTh is larger than the remaining amount (rate) cRM. Then, when it is determined that the current threshold value cTh is not larger than the remaining amount (rate) cRM (“NO” in Step S2004), the CPU 901 determines that the timing to provide the automatic delivery notification of the consumable has not arrived yet, and ends the process of the flowchart without performing any other steps.

Meanwhile, when it is determined that the current threshold value cTh is larger than the remaining amount (rate) cRM (“YES” in Step S2004), the CPU 901 determines that the timing to provide the automatic delivery notification of the consumable has arrived, and advances the process to Step S2005. In Step S2005, the CPU 901 transmits the automatic delivery notification signal to the CPU 801, and ends the process of the flowchart. As described above, the CPU 901 serving as a decision portion decides, based on the consumption information and the reservation setting information, a timing to provide a notification for prompting preparation of the replacement article of the consumable. When receiving the automatic delivery notification signal, the CPU 801 provides a notification for arranging preparation of the replacement article of the consumable (automatic delivery notification of consumable). For example, to provide the automatic delivery notification of the consumable, the CPU 801 serving as a notification portion sends to an external apparatus (e.g., maintenance system (not shown)) a notification for requesting delivery of the replacement article (e.g., email for ordering the replacement article) in order to arrange the consumable, and controls the UI portion controller 820 to display on the UI portion 600 a screen for requesting the person in charge of maintenance to prepare the replacement article.

While the toner bottle is described as an example of the consumable in the embodiment, a process unit, a fixing device, a residual toner container, and other such members that can be replaced by a user are well known in addition to the toner bottle, and the consumable is not limited to the toner bottle.

Further, after the automatic delivery notification signal is sent out, the execution of the process of FIG. 7 or FIG. 8 may be omitted because whether or not to provide the automatic delivery notification does not need to be determined again until the relevant consumable is replaced.

While the case where the image forming portion 100 employs electrophotography is taken as an example for description in the embodiment, the present invention is applicable even to a case where the image forming portion 100 employs another printing method. In this case, an example of a consumable whose consumption state is monitored to provide a notification for preparing a replacement article is a recording agent suited to a printing method (ink or ink cartridge in a case of ink jet printing, for example).

As described above, according to the embodiment, in the image forming apparatus that can be changed over to a high-productivity model, the threshold value of the automatic delivery notification is caused to follow a change in productivity based on the reservation setting information for changeover to high productivity. Thus, even when the printing productivity of the image forming apparatus is changed over, the consumable of the image forming apparatus can be prepared (arranged) at a more appropriate timing as compared with the case where the method of the embodiment is not used.

In the embodiment described above, the configuration is described in which the CPU 901 of the image formation control CPU circuit portion 900 of the image forming apparatus 1000 executes the processes illustrated in FIG. 7 and FIG. 8, to thereby change the timing to provide the notification for preparing the replacement article of the consumable (automatic delivery notification). However, an apparatus outside the image forming apparatus 1000 may obtain necessary information from the image forming apparatus 1000 to change a timing to prepare the replacement article of the consumable of the image forming apparatus 1000.

Further, the reservation setting information shown in FIG. 5 may allow setting of the productivity after UP or a productivity UP rate (rate by which the productivity is increased by the increase in productivity). In this configuration, the value of “(productivity after UP)/(standard productivity)” shown in Expression 1 given above is calculated based on the productivity after UP or the productivity UP rate (rate by which the productivity is increased by the increase in productivity) included in the reservation setting information.

Still further, the present invention is not limited to an image forming apparatus, and is applicable to any apparatus on which a setting change that affects a consumption speed of a consumable can be made. Thus, even when a setting change that affects the consumption speed of the consumable of an apparatus is made, the consumable can be prepared (arranged) at a more appropriate timing as compared with the case where the present invention is not used.

The above-mentioned configuration and details of various kinds of data are not limited to the ones described above, and may be formed of various configurations and details depending on the use and purpose.

One embodiment of the present invention has been described above, but the present invention may be embodied as a system, an apparatus, a method, a program, or a storage medium, for example. Specifically, the present invention may be applied to a system formed of a plurality of devices, or to an apparatus formed of one device.

Further, all configurations obtained by combining the above-mentioned embodiments are encompassed by the present invention.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-163043, filed Aug. 23, 2016, which is hereby incorporated by reference herein in its entirety.

What is claimed is:

1. An image forming apparatus, comprising:
an image forming portion configured to form an image on a recoding medium;
an obtaining unit configured to obtain consumption information indicating a consumption state of a consumable mounted to the image forming apparatus;
a setting unit configured to set changeover information including information indicating a period in which productivity of the image forming apparatus is to be changed over;
a control portion configured to control the image forming portion in order to change over the productivity of the image forming apparatus based on the changeover information; and
a decision portion configured to decide, based on the consumption information and the changeover information, a timing to provide a notification for prompting preparation of a replacement article of the consumable.

2. An image forming apparatus according to claim 1, wherein the decision portion calculates, based on the changeover information, a proportion of the period in which the productivity is to be changed over to a preset period required for preparation of the consumable, and decides the timing to provide the notification based on the proportion of the period in which the productivity is to be changed over.

3. An image forming apparatus according to claim 2, wherein the decision portion decides the timing to provide the notification based on the proportion of the period in which the productivity is to be changed over and on a rate by which the productivity is increased by the changeover of the productivity.

4. An image forming apparatus according to claim 1, wherein the decision portion compares the consumption information obtained by the obtaining unit with a predetermined threshold value to determine the timing to provide the notification, and
wherein the decision portion corrects the predetermined threshold value based on the changeover information and decides the timing to provide the notification based on the corrected predetermined threshold value.

5. An image forming apparatus according to claim 1, further comprising a notification portion configured to transmit to an external apparatus a notification for requesting delivery of the replacement article of the consumable.

6. An image forming apparatus according to claim 1, further comprising:
an operating portion; and
a notification portion configured to display on the operating portion a request to prepare the replacement article of the consumable.

7. An image forming apparatus according to claim 1, wherein the consumable comprises any one of toner, a toner bottle configured to contain toner, a process unit configured to form an image with toner, a fixing device configured to fix toner to a recording medium, developer, ink, and an ink cartridge.

8. A control method for an image forming apparatus, comprising:
obtaining consumption information indicating a consumption state of a consumable mounted to the image forming apparatus;
setting changeover information including information indicating a period in which productivity of the image forming apparatus is to be changed over;
controlling an image forming portion configured to form an image on a recoding medium in order to change over the productivity based on the changeover information; and
deciding, based on the consumption information and the changeover information, a timing to provide a notification for prompting preparation of a replacement article of the consumable.

9. A non-transitory computer-readable storage medium which stores a program for causing a computer to execute a control method for an image forming apparatus, the control method comprising:
obtaining consumption information indicating a consumption state of a consumable mounted to the image forming apparatus;
setting changeover information including information indicating a period in which productivity of the image forming apparatus is to be changed over;
controlling an image forming portion configured to form an image on a recoding medium in order to change over the productivity based on the changeover information; and
deciding, based on the consumption information and the changeover information, a timing to provide a notification for prompting preparation of a replacement article of the consumable.
